(19) United States
(12) Patent Application Publication
(10) Pub. No.: US 2019/0139697 A1
(43) Pub. Date: May 9, 2019

(54) MAGNETIC ELEMENT, METAL ANNULAR WINDING AND METHOD FOR MANUFACTURING THE SAME

(71) Applicant: Delta Electronics (Shanghai) Co.,Ltd., Shanghai (CN)

(72) Inventors: Zengyi LU, Shanghai (CN); Lihua GE, Shanghai (CN); Tianding HONG, Shanghai (CN)

(21) Appl. No.: 16/175,861

(22) Filed: Oct. 31, 2018

(30) Foreign Application Priority Data
Nov. 9, 2017 (CN) 201711096353.6

(51) Int. Cl. H01F 27/34; H01F 27/32; H01F 41/06; H01F 27/30

(52) U.S. Cl. CPC H01F 27/34; H01F 27/325; H01F 2027/348; H01F 27/306; H01F 41/06

(57) ABSTRACT

The present invention discloses a magnetic element, a metal annular winding and a method of manufacturing the same. The metal annular winding includes a first flat plate portion, a winding support portion and a through hole. The winding support portion is disposed on the first flat plate portion; the through hole is formed in the middle of each of the first flat plate portion and the winding support portion; both the first flat plate portion and the winding support portion enclose the through hole in a ring shape.

### CROSS-REFERENCE TO RELATED APPLICATIONS

This non-provisional application claims priority under 35 U.S.C. § 119(a) on Patent Application No. 201711096353.6 filed in P.R. China on Nov. 9, 2017, the entire contents of which are hereby incorporated by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### BACKGROUND OF THE INVENTION

### 1. Field of the Invention

The present invention relates to a magnetic element, a metal annular winding and a method for manufacturing the same, and particularly to a metal annular winding in which a winding space is formed of a flat plate portion and a winding support portion, a method for manufacturing the same, and a magnetic element including the metal annular winding.

### 2. Related Art

Along with development of large current output, a secondary winding in a magnetic element (e.g., a transformer) is usually of a copper sheet structure, such as a copper sheet Q shown in FIG. 1. FIG. 1 is a schematic view of a structure of a conventional magnetic element in which a primary winding P is of a winding structure around a bobbin B.

In order to reduce eddy current losses, the primary and secondary windings in the magnetic element are generally designed as a staggered structure. As shown in FIG. 1, the bobbin B is used for supporting the windings of the primary winding P, and includes blades and pipe walls for forming a winding space. Restricted by material of the bobbin B and the injection molding process, the blades and the pipe walls usually have a thickness greater than 0.7 mm. The bobbin B including the blades and the pipe walls may account for a great proportion in the winding space, up to about 34.2% of winding window space of a magnetic core, which becomes a technical bottleneck of miniaturizing the magnetic element.

Accordingly, in order to increase the power density of the magnetic element, it is highly demanded in the art to reduce the space occupancy of the bobbin B and to reduce the overall size of the magnetic element.

### SUMMARY OF THE INVENTION

In order to overcome the above-mentioned problems existing in the prior art, it is an object of the present invention to provide a metal annular winding, including a first flat plate portion; a winding support portion, which is disposed on the first flat plate portion; and a through hole, which is formed in the middle of each of the first flat plate portion and the winding support portion, the first flat plate portion and the winding support portion both enclosing the through hole in a ring shape.

The present invention further provides a magnetic element, comprising the metal annular winding described as above; a magnetic core, including at least one core column; and a second winding, wound around the winding support portion of the metal annular winding. The core column is disposed inside the through hole of the metal annular winding.

The present invention further provides a method for manufacturing a metal annular winding, comprising the following steps:

S1: separating a sheet metal along a closed contour curve with a die to obtain a first shape structure;

S2: setting a first bending line to divide the first shape structure into a first flat plate portion and a winding support portion;

S3: performing a first bending process on the first shape structure along the first bending line to form a second shape structure; and

S4: performing a ring-shaped bending process on the second shape structure to form the metal annular winding, leaving the head and end of the ring shape of the metal annular winding unclosed.

Compared with the prior art, the present invention has the following technical effects, all or part of which are beneficial. The metal annular winding according to the present invention can be used both as a winding for providing an electrical function and as a winding support structure for other windings. Therefore, compared with a conventional magnetic element having the bobbin, when the metal annular winding according to the present invention is applied to a magnetic element, the winding space may be saved by about 30%, thereby increasing space utilization of the winding window of the magnetic element and reducing the overall size of the product.

### BRIEF DESCRIPTION OF THE DRAWINGS

FIG. 1 is a schematic view of a structure of a conventional magnetic element;

FIG. 2 is a schematic view showing a structure of a first embodiment of a metal annular winding according to the present invention;

FIG. 3 is a cross-sectional view of FIG. 2 taken along a line A-A′;

FIG. 4 is a schematic view showing a structure of a second embodiment of the metal annular winding according to the present invention;

FIG. 5 is a cross-sectional view of FIG. 4 taken along a line B-B′;

FIG. 6 is a cross-sectional view showing a third embodiment of the metal annular winding according to the present invention;

FIG. 7 is a schematic view showing a structure of a fourth embodiment of the metal annular winding according to the present invention;

FIG. 8 is a schematic view showing a structure of a fifth embodiment of the metal annular winding according to the present invention;

FIG. 9 is a schematic view showing a structure of a sixth embodiment of the metal annular winding according to the present invention;

FIG. 10 is a schematic view showing a structure of a first embodiment of the magnetic element according to the present invention;

FIG. 11 is a schematic view showing a structure of a second embodiment of the magnetic element according to the present invention;

FIG. 12 is a schematic view showing an assembled structure of the metal annular winding and second windings in FIG. 11;

FIG. 13 is a view showing a process for manufacturing the metal annular winding in FIG. 4;

FIG. 14 is a view showing a process for manufacturing the metal annular winding in FIG. 7;

FIG. 15 is a view showing a process for manufacturing the metal annular winding in FIG. 8;

FIG. 16 is a view showing a process for manufacturing the metal annular winding in FIG. 9;

FIG. 17 is a flow chart of a first embodiment of a method for manufacturing the metal annular winding according to the present invention; and

FIG. 18 is a flow chart of a second embodiment of the method for manufacturing the metal annular winding according to the present invention.

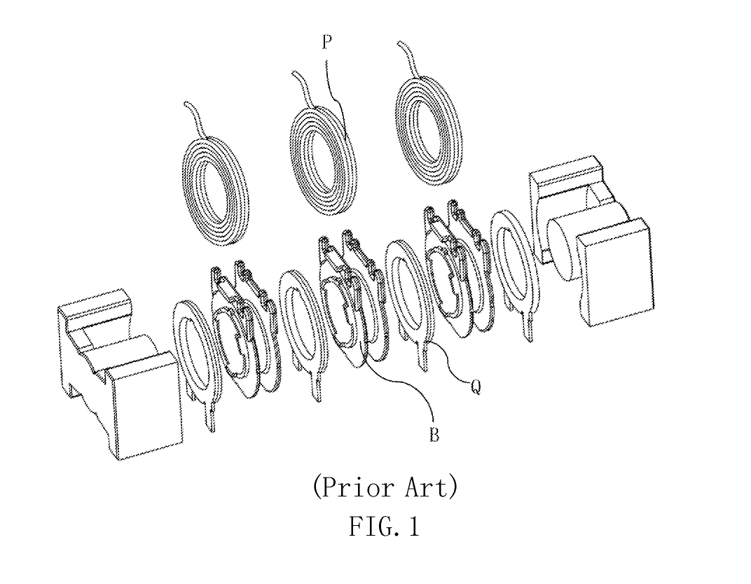

### DETAILED DESCRIPTION OF THE INVENTION

Hereinafter the present invention will be further described in detail with reference to the accompanying drawings and embodiments. The embodiments were carried out on the premise of the technical solution of the present invention, and the embodiments and operation processes are given. However, the protection scope of the present invention is not limited to the following embodiments.

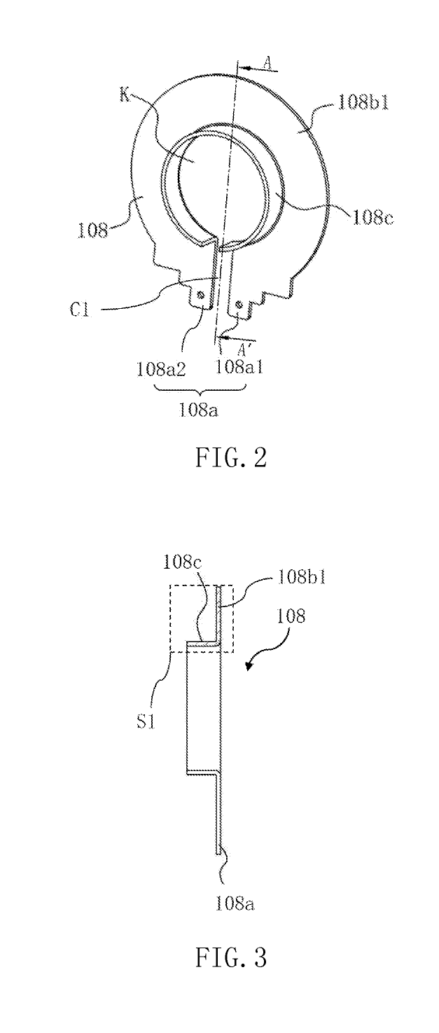

Referring to FIGS. 2 and 3, FIG. 2 is a schematic view showing a structure of a first embodiment of a metal annular winding 108 according to the present invention, and FIG. 3 is a cross-sectional view of FIG. 2 taken along the line A-A′. As shown in FIGS. 2 and 3, the metal annular winding 108 includes a winding support portion 108c and a first flat plate portion 108b1. The winding support portion 108c is disposed on the first flat plate portion 108b1. The winding support portion 108c may be perpendicular to the first flat plate portion 108b1. As shown in FIG. 3, the first flat plate portion 108b1 is connected to the winding support portion 108c, forming an L-shaped cross-section S1.

Further, the metal annular winding 108 includes a through hole K. The through hole K passes through the first flat plate portion 108b1 and the winding support portion 108c. That is, both the first flat plate portion 108b1 and the winding support portion 108c have an annular shape, with the through hole K formed in a common central portion of the first flat plate portion 108b1 and the winding support portion 108c. Further, both the first flat plate portion 108b1 and the winding support portion 108c are configured as surrounding the through hole K.

Moreover, in order to prevent short-circuit, the metal annular winding 108 further includes a first opening C1. The first opening C1 extends from the outermost periphery of the first flat plate portion 108b1 to the uppermost end of the winding support portion 108c, wherein the uppermost end of the winding support portion 108c refers to an end away from the first flat plate portion 108b1.

Further, the first flat plate portion 108b1 may be provided with a conductive connecting part 108a for connecting the metal annular winding 108 with other electronic components, such as a printed circuit board. The conductive connecting part 108a may include two terminals 108a1 and 108a2, but the present invention is not limited thereto.

In this embodiment, the first flat plate portion 108b1 and the winding support portion 108c are integrally formed, but the present invention is not limited thereto.

Windings may be wound on the winding support portion 108c. The first flat plate portion 108b1 may at least partially limit the position of the windings. The winding support portion 108c and the first flat plate portion 108b1 together form a winding space.

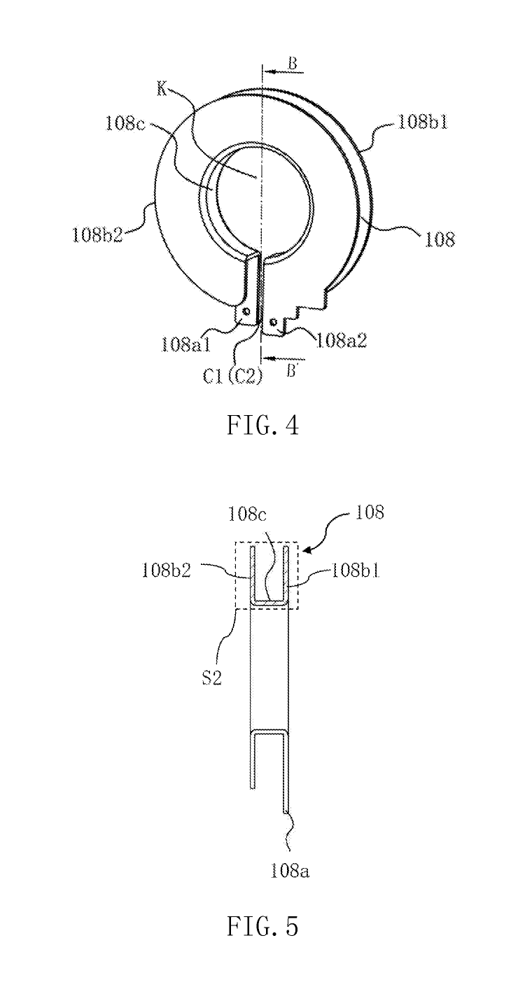

Referring to FIGS. 4 and 5, FIG. 4 is a schematic view showing a structure of a second embodiment of the metal annular winding 108 according to the present invention, and FIG. 5 is a cross-sectional view of FIG. 4 taken along the line B-B′. As shown in FIGS. 4 and 5, the metal annular winding 108 according to this embodiment differs from the first embodiment shown in FIGS. 2 and 3 in that it further includes a second flat plate portion 108b2. The second flat plate portion 108b2 is disposed on the winding support portion 108c. The second flat plate portion 108b2 may be perpendicular to the winding support portion 108c. That is, the second flat plate portion 108b2 is formed in parallel with the first flat plate portion 108b1. As shown in FIG. 5, the winding support portion 108c is connected between the first flat plate portion 108b1 and the second flat plate portion 108b2, forming a U-shaped cross-section S2.

In this embodiment, the metal annular winding 108 also includes a through hole K. The through hole K passes through the first flat plate portion 108b1, the winding support portion 108c, and the second flat plate portion 108b2. That is, all the first flat plate portion 108b1, the winding support portion 108c, and the second flat plate portion 108b2 have an annular shape, with the through hole K formed in a common central portion of the first flat plate portion 108b1, the winding support portion 108c, and the second flat plate portion 108b2. Further, all the first flat plate portion 108b1, the winding support portion 108c, and the second flat plate portion 108b2 are configured as surrounding the through hole K.

Moreover, in addition to the first opening C1, the metal annular winding 108 further includes a second opening C2. As shown in FIG. 4, the second opening C2 extends inwardly from the outer periphery surface of the second flat plate portion 108b2 to the inner circumference of the winding support portion 108c, and is communicated with the first opening C1.

In this embodiment, the conductive connecting part 108a for connecting the metal annular winding 108 with other electronic components, such as a printed circuit board, may also be provided. The conductive connecting part 108a may also include two terminals 108a1 and 108a2. In this embodiment, the two terminals 108a1 and 108a2 may be provided on the first flat plate portion 108b1 and the second flat plate portion 108b2 respectively, which is easier to connect with the printed circuit board, but the present invention is not limited thereto.

In this embodiment, the first flat plate portion 108b1, the winding support portion 108c and the second flat plate portion 108b2 are integrally formed, but the present invention is not limited thereto.

Windings may be wound on the winding support portion 108c. The first flat plate portion 108b1 and the second flat plate portion 108b2 may cooperate to at least partially limit the position of the windings. The winding support portion 108c, the first flat plate portion 108b1, and the second flat plate portion 108b2 together form a winding space.

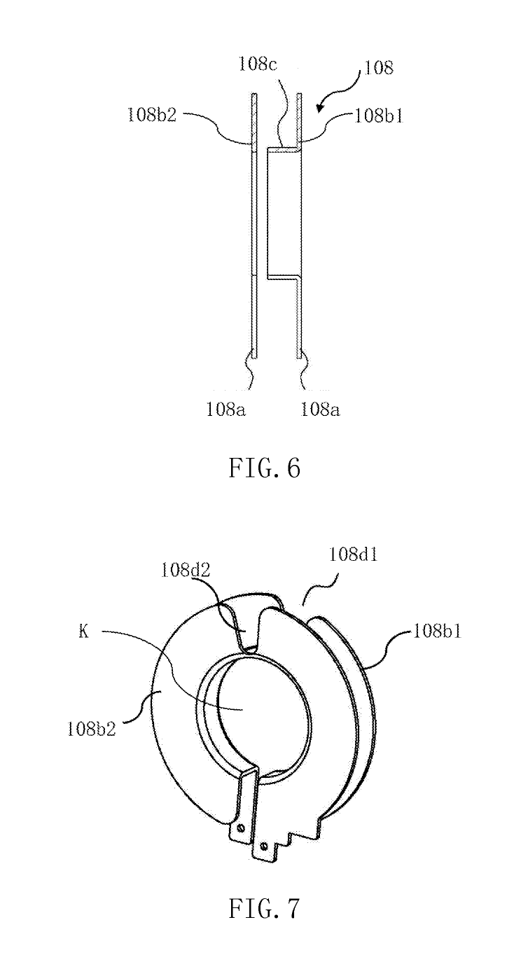

Referring to FIG. 6, FIG. 6 is a cross-sectional view showing a third embodiment of the metal annular winding 108 according to the present invention. The metal annular winding shown in FIG. 6 has substantially the same structure as that of the metal annular winding shown in FIG. 4. Therefore, the description of same elements will be omitted below, and description will mainly focus on the differences.

In this embodiment, the first flat plate portion 108b1 and the winding support portion 108c are integrally formed, while the second flat plate portion 108b2 is an individual component. Further, in this embodiment, the first flat plate portion 108b1 and the second flat plate portion 108b2 may each include a conductive connecting part 108a, but the present invention is not limited thereto.

Referring to FIG. 7, FIG. 7 is a schematic view showing a structure of a fourth embodiment of the metal annular winding 108 according to the present invention. The metal annular winding shown in FIG. 7 has substantially the same structure as that of the metal annular winding shown in FIG. 4. Therefore, the description of same elements will be omitted below, and description will mainly focus on the differences.

In this embodiment, a first wire passing groove 108d1 is provided on the first flat plate portion 108b1, and a second wire passing groove 108d2 is provided on the second flat plate portion 108b2. As shown in FIG. 7, the concavity of the wire passing grooves 108d1 and 108d2 is great, with the bottoms of the grooves approaching the through hole K. In this way, when a winding is wound on the winding supporting portion 108c, the winding may be fed in or from through the first wire passing groove 108d1 and the second wire passing groove 108d2, resulting in a neatly-arranged winding structure and improved utilization of the winding space. Moreover, the wire passing groove can also be used for placing a series connecting line for winding wires so as to connect one winding wire with another winding wire in series. Furthermore, in order to reduce the loss of the metal annular winding and improve its service life, the positions of the first wire passing groove 108d1 and the second wire passing groove 108d2 may be at least partially asymmetric with respect to the winding supporting portion 108c so as to maximize cross-sectional area of the current path.

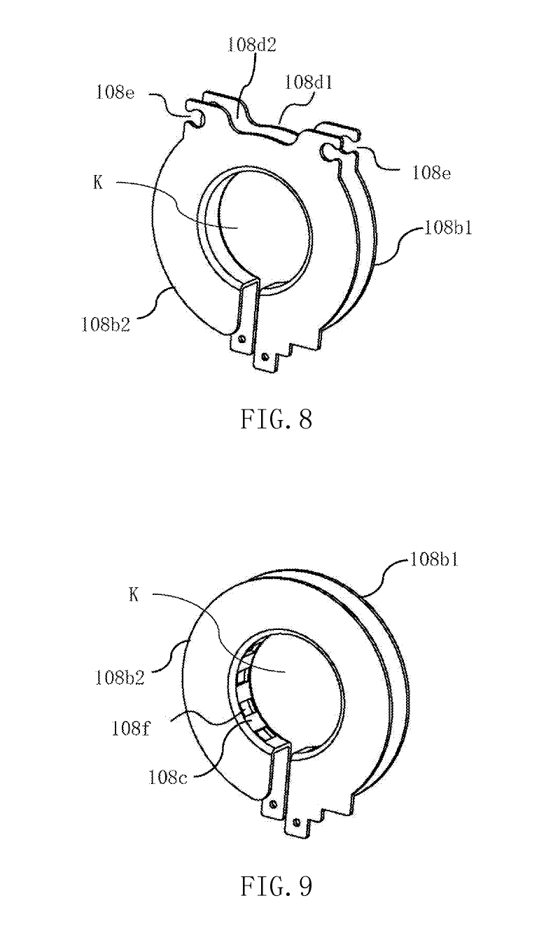

Referring to FIG. 8, FIG. 8 is a schematic view showing a structure of a fifth embodiment of the metal annular winding 108 according to the present invention. The metal annular winding shown in FIG. 8 has substantially the same structure as that of the metal annular winding shown in FIG. 4. Therefore, the description of same elements will be omitted below, and description will mainly focus on the differences.

In this embodiment, a first wire passing groove 108d1 is provided on the first flat plate portion 108b1, and a second wire passing groove 108d2 is provided on the second flat plate portion 108b2. Unlike the wire passing grooves in FIG. 7, the first wire passing groove 108d1 and the second wire passing groove 108d2 shown in FIG. 8 are shallow and are mainly used for placing a series connecting line for winding wires.

Further, in this embodiment, a pair of fly line locating holes 108e are symmetrically arranged on the first flat plate portion 108b1 and the second flat plate portion 108b2. The fly line locating holes 108e are used for locating a starting line and an ending line of a winding wire. In FIG. 8, the fly line locating holes 108e are shown as having a notched-circle shape, but the present invention is not limited thereto.

Referring to FIG. 9, FIG. 9 is a schematic view showing a structure of a sixth embodiment of the metal annular winding 108 according to the present invention. The metal annular winding shown in FIG. 9 has substantially the same structure as that of the metal annular winding shown in FIG. 4. Therefore, the description of same elements will be omitted below, and the following description will mainly focus on the differences therebetween.

In this embodiment, as shown in FIG. 9, a plurality of pipe wall slots 108f are provided on the circumference surface of the winding support portion 108c. The plurality of pipe wall slots 108f are disposed at intervals along the circumference surface of the winding support portion 108c. The pipe wall slots 108f are used for changing flowing direction of the current, so as to reduce losses.

Note that, although the wire passing grooves 108d1 and 108d2, the fly line locating holes 108e, and the pipe wall slots 108f shown in FIGS. 7-9 are described with respect to the embodiment of the metal annular winding 108 shown in FIG. 4, they may also be applied to the metal annular winding 108 shown in FIG. 2 or FIG. 6 with simple modification or variation.

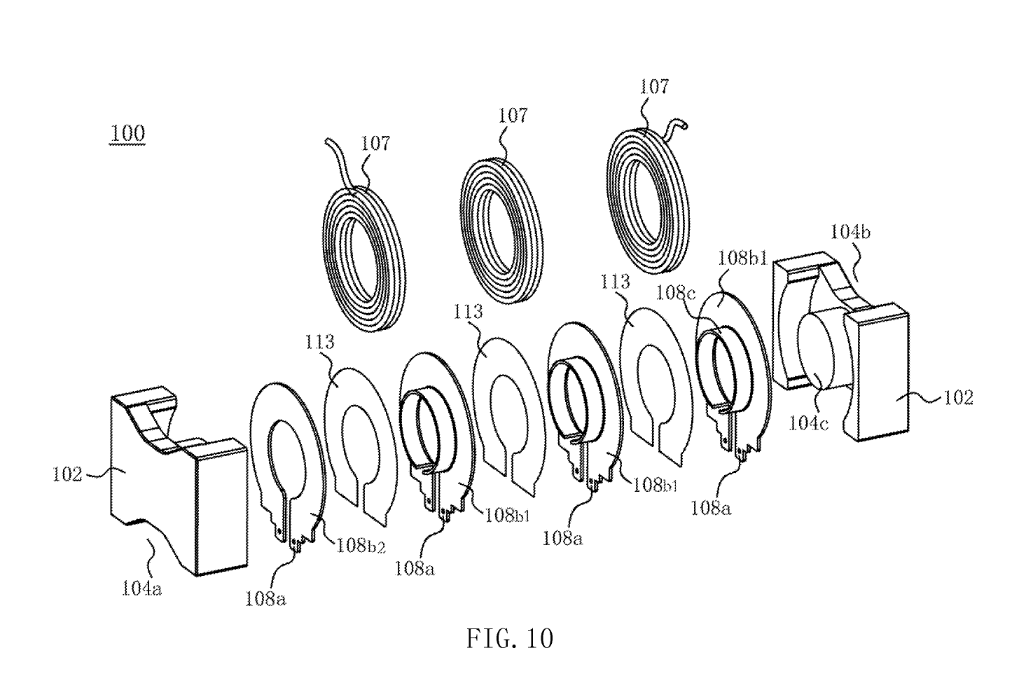

Referring to FIG. 10, FIG. 10 is a schematic view showing a structure of a first embodiment of a magnetic element according to the present invention (a magnetic element 100). As shown in FIG. 10, the magnetic element 100 comprises a magnetic core 102, a plurality of metal annular windings 108, and a plurality of second windings 107. The magnetic core 102 includes an upper magnetic core portion 104a and a lower magnetic core portion 104b which are opposite to each other, and a core column 104c. The specific structure of the metal annular winding 108 may be similar to the previously-mentioned embodiments of the metal annular winding 108, and thus detailed description will be omitted below.

In this embodiment, the magnetic core 102 is composed of two half-magnetic cores symmetric to each other, but the configuration of the magnetic core is not limited thereto. In addition, the number of the core column (s) 104c is not specifically limited in the present invention. In a case where the magnetic core 102 includes several core columns, one or more metal annular windings 108 may be provided on each core column.

In this embodiment, the magnetic core 102 is made of a ferrite material, but not limited thereto. Other magnetic materials may be used as necessary.

Referring to FIG. 10 again, the core column 104 may be disposed inside the through hole K of the metal annular windings 108. The plurality of metal annular windings 108 are sequentially stacked along the core column 104c. The plurality of second windings 107 are respectively wound around the winding support portions of the plurality of metal annular windings 108. In an embodiment, The conductive connecting part 108a of the metal annular windings 108 exposed from the upper magnetic core portion 104a and the lower magnetic core portion 104b so as to facilitate the connection with other electronic components, such as a printed circuit board. Among the metal annular windings 108, the metal annular winding 108 which is closest to the upper magnetic core portion 104a in an axis direction of the core column 104c may have a structure similar to the third embodiment shown in FIG. 6, in which each of the first flat plate portion 108b1 and the second flat plate portion 108b2 includes the conductive connecting part 108a. In such a structure, the first flat plate portion 108b1 and the winding support portion that are integrally formed may be equivalent to one turn of metal winding, while the second flat plate portion 108b2 as an independent component may be equivalent to another turn of metal winding. The rest metal ring windings 108 may have a structure similar to the first embodiment shown in FIG. 2, in which the first flat plate portion 108b1 includes the conductive connecting part 108a, and may be equivalent to one turn of metal winding. Further, for insulation purposes, an insulation strip 113 may be provided between respective turns of the metal windings. Specifically, the insulation strip 113 may be provided between any two adjacent metal annular windings 108. Further, with respect to the metal annular winding 108 which is closest to the upper magnetic core portion 104a in an axis direction of the core column 104c, the insulation strip 113 may further be provided between the second flat plate portion 108b2 and the winding support portion 108c.

In this embodiment, each of the second windings 107 is formed by winding a three layer insulated wire, so as to ensure the insulation between the second winding 107 and the corresponding metal annular winding 108. However, the type of the second windings 107 and the way of winding are not specifically limited in the present invention. Moreover, the numbers or the turns of the second windings 107 and the metal annular windings 108 may be adjusted according to the design requirement of a magnetic element.

In this embodiment, the magnetic element 100 may be a transformer; the metal annular winding 108 may be the secondary winding of the transformer; the second windings 107 may be the primary winding of the transformer; and the metal annular winding 108 may be a copper annular winding. However, the present invention is not limited thereto.

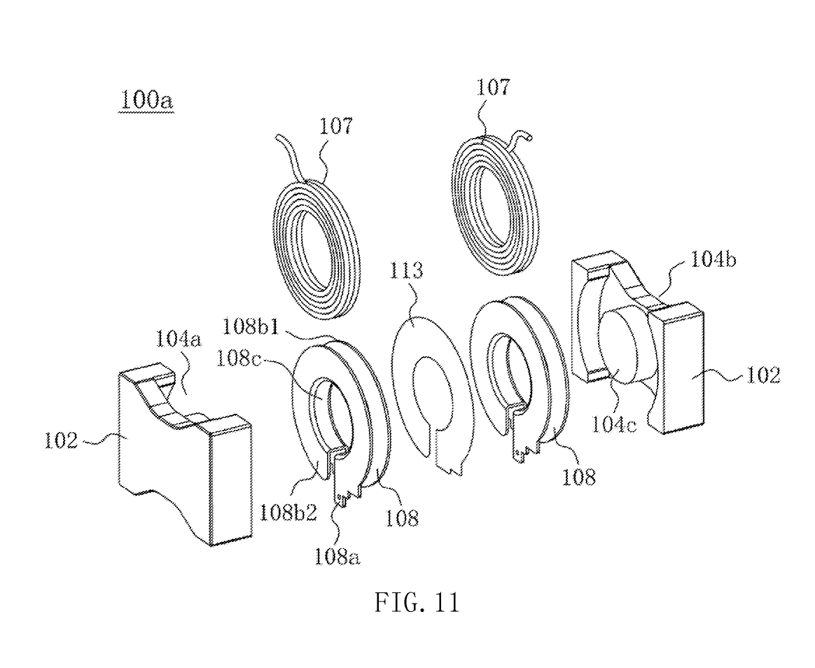

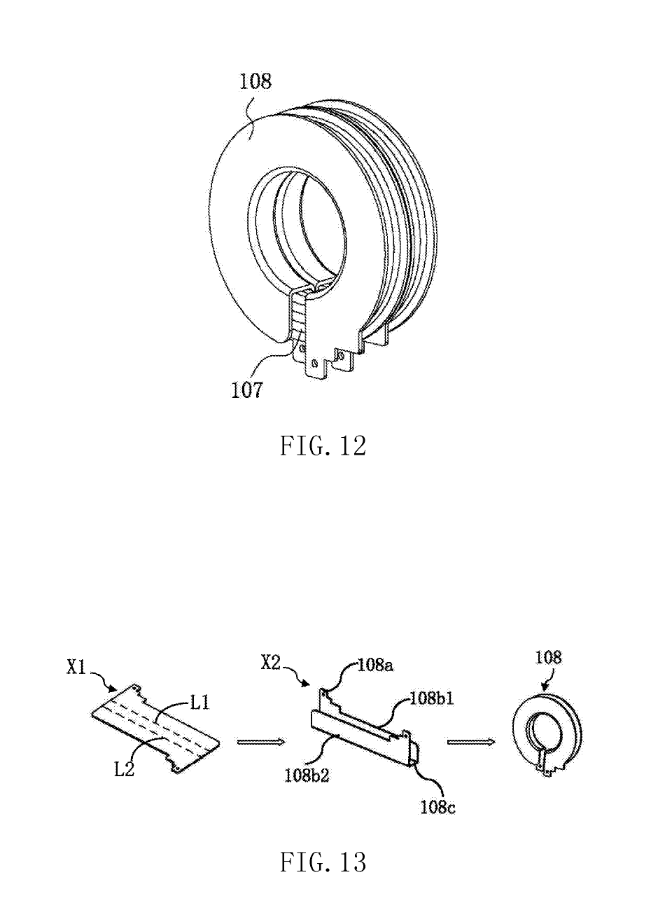

Referring to FIGS. 11 and 12, FIG. 11 is a schematic view showing a structure of a second embodiment of the magnetic element according to the present invention (a magnetic element 100a), and FIG. 12 is a schematic view showing an assembled structure of the metal annular winding 108 and the second windings 107 in FIG. 11. As shown in FIGS. 11 and 12, the magnetic element 100a includes a magnetic core 102, a plurality of metal annular windings 108, and a plurality of second windings 107. Here, the description of elements that are the same as those in FIG. 10 will be omitted below, and the following description will mainly focus on the differences therebetween.

The metal annular windings 108 of the magnetic element 100a in FIG. 11 may have a structure similar to the second embodiment shown in FIG. 5, in which each of the metal annular windings 108 is integrally formed and includes the conductive connecting part 108a, being equivalent to one turn of metal winding. For insulation purposes, the insulating strip 113 may be provided between respective turns of the metal windings. Specifically, the insulation strip 113 may be provided between any two adjacent metal annular windings 108. However, the present invention is not limited thereto.

In this embodiment, each of the second windings 107 may be correspondingly disposed on the winding support portions 108c of each metal annular winding 108. The structure of each of the second windings 107 is the same as that shown in FIG. 10, and thus detailed description will be omitted below.

In another embodiment of the present invention, the metal annular windings 108 in FIG. 11 may alternatively have a structure similar to the third embodiment shown in FIG. 6, in which each of the metal annular windings 108 includes the winding support portion 108c and the first flat plate portion 108b1 that are integrally formed, and the second flat plate portion 108b2 as an independent component. However, the present invention is not limited thereto. Any metal annular winding 108 in the magnetic element 100a may be of any one of the structures shown in FIGS. 2 to 9 as long as the position of the second windings 107 can be limited by the first flat plate portion 108b1 and/or the second plate portion 108b2. For example, each of the second windings 107 in FIG. 11 is wound on a corresponding metal annular winding 108. In this way, the position of the second winding 107 is limited by the first flat plate portion 108b1 and the second plate portion 108b2 of the corresponding metal annular winding 108, thereby improving the fixation property of the magnetic element. In FIG. 10, part of the metal annular windings 108 are not provided with the second flat plate portion 108b2. In this case, the position of the second winding wound thereon may be limited by the first flat plate portion 108b1 in an adjacent metal annular winding 108. With the above configuration, in addition to the improvement in the fixation property of the magnetic element as mentioned above, the present invention may further decrease the height of the magnetic element and increase the power density thereof, as compared with the structure shown in FIG. 11.

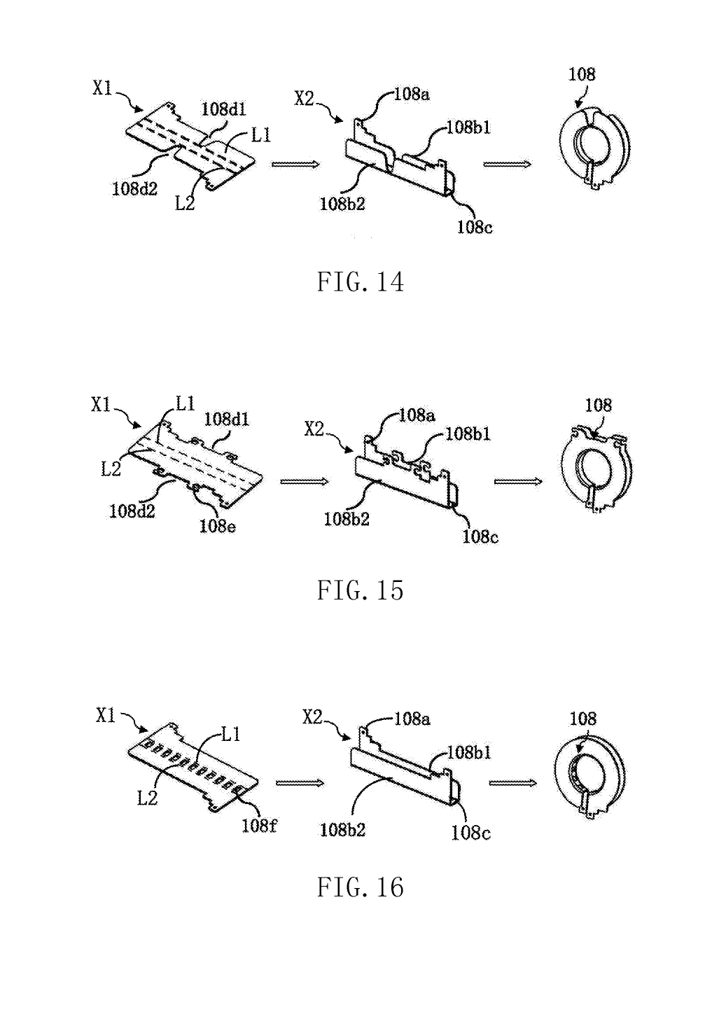

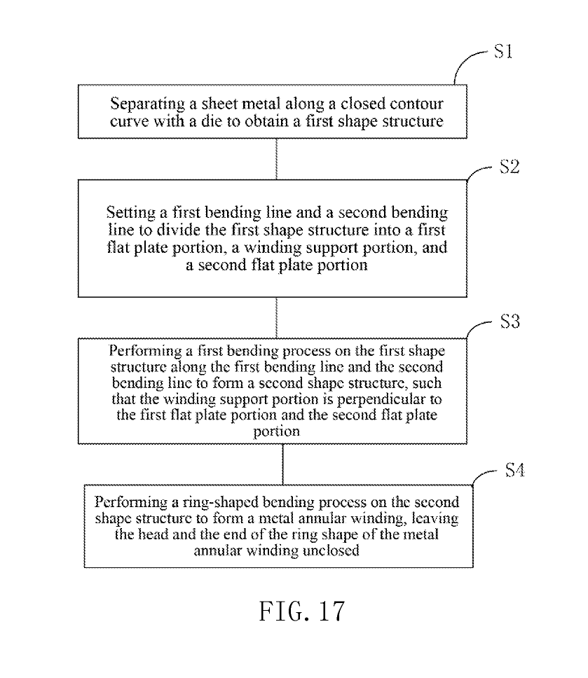

Referring to FIG. 17 and FIG. 13˜16, FIG. 17 is a flow chart of a first embodiment of a method for manufacturing the metal annular winding according to the present invention. The manufacturing method may be used to implement the second embodiment and the fourth to sixth embodiments of the metal annular winding 108 according to the present invention. FIG. 13 is a view showing a process for manufacturing the second embodiment of the metal annular winding 108 according to the present invention shown in FIG. 4, FIG. 14 is a view showing a process for manufacturing the fourth embodiment of the metal annular winding 108 according to the present invention show in FIG. 7, FIG. 15 is a view showing a process for manufacturing the fifth embodiment of the metal annular winding 108 according to the present invention show in FIG. 8, FIG. 16 is a view showing a process for manufacturing the sixth embodiment of the metal annular winding 108 according to the present invention show in FIG. 9. As shown in FIG. 17 and FIG. 13˜16, the method for manufacturing the metal annular winding according to the present invention comprises the following steps.

S1: separating a sheet metal along a closed contour curve with a die to obtain a first shape structure X1 (FIG. 13).

S2: setting a first bending line L1 and a second bending line L2 to divide the first shape structure X1 into the first flat plate portion 108b1, the winding support portion 108c, and a second flat plate portion 108b2 (FIG. 13).

S3: performing a first bending process on the first shape structure X1 along the first bending line L1 and the second bending line L2 to form a second shape structure X2. The winding support portion 108c may be perpendicular to the first flat plate portion 108b1 and the second flat plate portion 108b2 (FIG. 13). Here, the first bending process is an U-shaped bending process, but the present invention is not limited thereto.

S4: performing a ring-shaped bending process on the second shape structure X2 to form the metal annular winding 108, leaving the head and the end of the ring shape of the metal annular winding 108 unclosed (FIG. 13), wherein the ring-shaped bending process is at least one of a circular-shaped bending process, a square-shaped bending process, and a racetrack-shaped bending process.

Further, the step S1 comprises: punching and shearing the first flat plate portion 108b1 and the second flat plate portion 108b2 to form the conductive connecting part 108a (FIG. 13).

Still further, the step S1 comprises: punching and shearing the first flat plate portion 108b1 and the second flat plate portion 108b2 to form wire passing grooves 108d1, 108d2 (FIGS. 14 and 15).

In another embodiment of the present invention, the step S1 further comprises: punching and shearing the first flat plate portion 108b1 and the second flat plate portion 108b2 to form fly line locating holes (FIG. 16).

In still another embodiment of the present invention, the step S1 further comprises: punching and shearing the winding support portion 108c to form a plurality of pipe wall slots 108f.

For example, from left to right, in each of FIGS. 13 to 16 are: a first shape structure X1, a second shape structure X2 obtained by a U-shaped bending process, a metal annular winding 108 obtained by a ring-shaped bending process. With the above manufacturing method according to the present invention, a sheet metal, such as a copper sheet, may be processed into a first flat plate portion 108b1, a second flat plate portion 108b2, a winding support portion 108c, and a conductive connecting part 108a integrally formed.

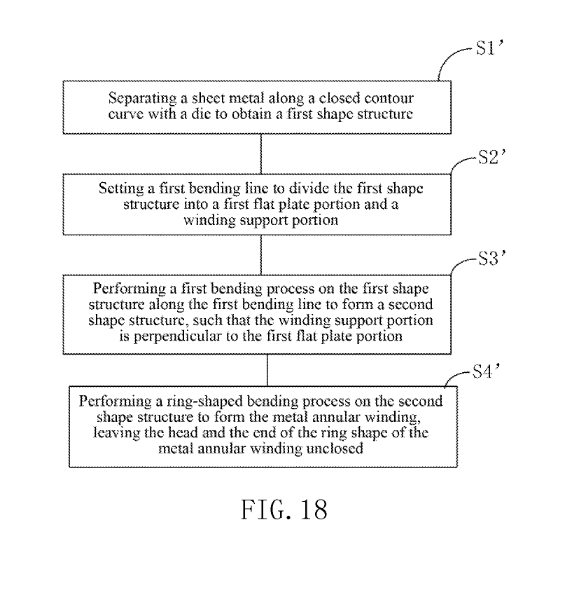

Referring to FIG. 18, FIG. 18 is a flow chart of a second embodiment of the method for manufacturing the metal annular winding according to the present invention. The manufacturing method may be used to form the metal annular winding 108 according to the first embodiment of the present invention shown in FIG. 3. As shown in FIG. 18, the method for manufacturing the metal annular winding according to the present invention comprises the following steps.

S1′: separating a sheet metal along a closed contour curve with a die to obtain a first shape structure.

S2′: setting a first bending line to divide the first shape structure into a first flat plate portion and a winding support portion.

S3′: performing a first bending process on the first shape structure along the first bending line to form a second shape structure. The winding support portion may be perpendicular to the first flat plate portion. Here, the first bending process is a L-shaped bending process, but the present invention is not limited thereto; and

S4′: performing a ring-shaped bending process on the second shape structure to form the metal annular winding, leaving the head and the end of the ring shape of the metal annular winding unclosed, wherein the ring-shaped bending process is at least one of a circular-shaped bending process, a square-shaped bending process and a racetrack-shaped bending process.

Similar to the first embodiment of the method for manufacturing the metal annular winding according to the present invention, the step S1′ may further comprise any combination of the following steps: a step of punching and shearing the first flat plate portion to form the conductive connecting part; a step of punching and shearing the first flat plate portion to form wire passing grooves, a step of punching and shearing the first flat plate portion to form fly line locating holes, and a step of punching and shearing the winding support portion to form a plurality of pipe wall slots. With the above manufacturing method according to the present invention, a sheet metal, such as a copper sheet, may be processed into a first flat plate portion, a winding support portion, and a conductive connecting part integrally formed.

In summary, the metal annular winding according to the present invention can be used both as a winding for providing an electrical function and as a winding support structure for other windings. Compared with a conventional magnetic element in which the bobbin has a staggered structure, when the metal annular winding according to the present invention is applied to a magnetic element, the winding space may be saved by about 30%, thereby increasing space utilization of the winding window of the magnetic element and reducing the overall size of the product.

It is to be noted that the above embodiments are only used to illustrate the present invention but not to limit the technical solution described in the present invention; moreover, although the present invention is described in detail with reference to the above embodiments in this specification, the ordinary persons skilled in the art should understand that changes or equivalent substitutions can still be made to the present invention; thus, all the technical solutions not departing from the spirit and scope of the present invention and the improvements thereof should be covered by the protection scope of the appended claims of the present invention.

What is claimed is:

1. A metal annular winding, including:
a first flat plate portion having an annular shape;
a winding support portion having an annular shape, which is disposed on the first flat plate portion; and
a through hole formed in a common central portion of the first flat plate portion and the winding support portion, both the first flat plate portion and the winding support portion surrounding the through hole.

2. The metal annular winding according to claim 1, wherein the first flat plate portion and the winding support portion are integrally formed.

3. The metal annular winding according to claim 1, wherein the metal annular winding further comprises a second flat plate portion having an annular shape which is disposed on the winding support portion,
wherein the through hole is formed in a common central portion of the first flat plate portion, the winding support portion, and the second flat plate portion, the second flat plate portion surrounding the through hole.

4. The metal annular winding according to claim 3, wherein the first flat plate portion, the winding support portion, and the second flat plate portion are integrally formed.

5. The metal annular winding according to claim 1, wherein a first wire passing groove is provided on the first flat plate portion.

6. The metal annular winding according to claim 3, wherein a first wire passing groove is provided on the first flat plate portion, and a second wire passing groove is provided on the second flat plate portion,
wherein, the positions of the first wire passing groove and the second wire passing groove are at least partially asymmetrical with respect to the winding supporting portion.

7. The metal annular winding according to claim 1, wherein fly line locating holes are provided on the first flat plate portion.

8. The metal annular winding according to claim 3, wherein fly line locating holes are provided on the first flat plate portion and the second flat plate portion.

9. The metal annular winding according to claim 1, wherein a plurality of pipe wall slots are provided on the inner circumference of the winding support portion, the pipe wall slots being disposed at intervals along the inner circumference of the winding support portion.

10. The metal annular winding according to claim 1, wherein the first flat plate portion has a conductive connecting part.

11. The metal annular winding according to claim 4, wherein the first flat plate portion and the winding support portion are integrally formed, while the second flat plate portion is an individual component, each of the first flat plate portion and the second flat plate portion having a conductive connecting part.

12. A magnetic element, comprising:
a metal annular winding, including:
a first flat plate portion having an annular shape;
a winding support portion having an annular shape, which is disposed on the first flat plate portion; and
a through hole formed in a common central portion of the first flat plate portion and the winding support portion, both the first flat plate portion and the winding support portion surrounding the through hole;
a magnetic core, including at least one core column; and
a second winding, wound around the winding support portion of the metal annular winding,
wherein the core column is disposed inside the through hole of the metal annular winding.

13. The magnetic element according to claim 12, wherein the magnetic element comprises a plurality of metal annular windings and a plurality of second windings, each of the plurality of second windings being correspondingly disposed on the winding support portion in each of the plurality of metal annular windings;
wherein the plurality of metal annular windings are sequentially stacked along the core column.

14. The magnetic element according to claim 13, wherein an insulating strip is arranged between any two adjacent metal annular windings among the plurality of metal annular windings.

15. The magnetic element according to claim 12, wherein the second winding is formed by winding a three-layer insulated wire.

16. A method for manufacturing a metal annular winding, comprising the following steps:
S1: separating a sheet metal along a closed contour curve with a die to obtain a first shape structure;
S2: setting a first bending line to divide the first shape structure into a first flat plate portion and a winding support portion;
S3: performing a first bending process on the first shape structure along the first bending line to form a second shape structure; and
S4: performing a ring-shaped bending process on the second shape structure to form the metal annular winding, leaving the head and end of the ring shape of the metal annular winding unclosed.

17. The manufacturing method according to claim 16, wherein
the step S2 further comprises:
setting a second bending line, the first bending line and the second bending line dividing the first shape structure into the first flat plate portion, the winding support portion and a second flat plate portion; and
the step S3 further comprises:
performing a first bending process on the first shape structure along the first bending line and the second bending line to form a second shape structure,
wherein the first bending process is a U-shaped bending process.

18. The manufacturing method according to claim 16, wherein the first bending process is an L-shaped bending process.

19. The manufacturing method according to claim 16, wherein the step S1 further comprises: punching and shearing the first flat plate portion to form wire passing grooves.

20. The manufacturing method according to claim 16, wherein the step S1 further comprises: punching and shearing the first flat plate portion to form fly line locating holes.

21. The manufacturing method according to claim 16, wherein the step S1 further comprises: punching and shearing the winding support portion to form a plurality of pipe wall slots.

22. The manufacturing method according to claim 16, wherein the step S1 further comprises: punching and shearing the first flat plate portion to form a conductive connecting part.

23. The manufacturing method according to claim 17, wherein the step S1 further comprises: punching and shearing the first flat plate portion and the second flat plate portion to form a wire passing groove.

24. The manufacturing method according to claim 17, wherein the step S1 further comprises: punching and shearing the first flat plate portion and the second flat plate portion to form a fly line locating hole.

25. The manufacturing method according to claim 17, wherein the step S1 further comprises: punching and shearing the first flat plate portion and the second flat plate portion to form a conductive connecting part.

26. The manufacturing method according to claim 16, wherein the ring-shaped bending process is at least one of a circular-shaped bending process, a square-shaped bending process and a racetrack-shaped bending process.
